(19) United States
(12) Patent Application Publication
(10) Pub. No.: US 2013/0340635 A1
(43) Pub. Date: Dec. 26, 2013

(54) RESIDUAL STRESS REDUCTION IN WELDING

(71) Applicants: Mats Gardin, Vasteras (SE); Stefan Sehlstedt, Vasteras (SE)

(72) Inventors: Mats Gardin, Vasteras (SE); Stefan Sehlstedt, Vasteras (SE)

(73) Assignee: Avure Technologies AB, Vasteras (SE)

(21) Appl. No.: 13/978,628

(22) PCT Filed: Jan. 7, 2011
(86) PCT No.: PCT/EP2011/050167

§ 371 Date: Sep. 11, 2013

(51) Int. Cl. B30B 15/02

(52) U.S. Cl. CPC B30B 15/02
USPC 100/246; 29/428

(57) ABSTRACT

A pressure vessel comprising a pressure chamber (5) arranged for accommodating a pressure medium, comprising at least one cylinder segment (2) arranged for longitudinal connection to form a cylinder body (1), whereby a joint (7) arranged for an interconnection is formed at adjacent longitudinal edges (6) of the at least one cylinder segment. The pressure vessel further comprises pre-stressing means (20) provided around an outer envelope surface (4) of the cylinder body for radially pre-stressing the cylinder body and for at least partly decreasing a gap (11) extending along at least a portion of each joint between adjacent longitudinal edges of the at least one cylinder segment.

### FIELD OF THE INVENTION

The present invention relates to the field of high pressure pressing, and in particular, a pressure vessel for isostatic pressing.

### BACKGROUND OF THE INVENTION

High-pressure presses are often used for the densification of powdered or cast materials, such as e.g. turbine blades for aircrafts, to achieve elimination of material porosity. Hence, pressure is applied to an article placed in the press in order to substantially increase the service life and the strength of the article, in particular the fatigue strength. Another field of application is the manufacture of products which are required to be fully dense and to have pore-free surfaces.

An article to be subjected to treatment by high-pressure pressing is positioned in a load compartment of a pressure chamber. After loading, the chamber is sealed off and a pressure medium, either a liquid or a gas, is introduced into the pressure chamber and the load compartment thereof. The press usually comprises a furnace provided with electric heating elements for increasing the temperature in the pressure chamber. The pressure and temperature of the pressure medium is increased, subjecting the article to a high pressure and temperature during a selected period of time. When the pressing of the articles is finished, the articles often need to be cooled before being removed, or unloaded, from the pressure chamber.

The pressures, temperatures, and treatment times are dependent on factors such as e.g. the material properties of the article to be treated, the field of application and/or the required quality of the article. Depending on the temperature of the pressure medium during an isostatic pressing process, the process can be called a hot isostatic pressing (hereinafter referred to as HIP), wherein the pressures typically may reach up to 300 MPa, warm isostatic pressing (herein referred to as a WIP), or cold isostatic pressing (hereinafter referred to as CIP), wherein the pressures can reach up to 700 MPa.

A cylinder for a high-pressure press is traditionally manufactured by forging, wherein a body is first cast and subsequently forged. More specifically, a rough cylindrical body is first cast, which is then forged to expand into a hollow cylinder body of suitable diameter and wall thickness. The forging process provides the advantage of increasing the strength of the cast material. In order to withstand high internal pressures, the cylinder body is then pre-stressed by means which radially compress the cylinder, the cylinder wall thereby being subjected to tangential compressive stresses. Pre-stressing further minimizes the risk of crack formation/propagation in the cylinder wall and, hence, reduces the risk of pressure vessel failure.

For the manufacture of very large cylinders, high demands are put on the equipments for the forging-, heat treatment- and machining processes. Recently, an increased demand for larger and larger sizes of the articles to be pressed has evolved, implying a demand for an increase of the volumes of the pressure chambers, often beyond what is possible with the pressure vessels of today. In addition, the conventional production method described above is complex and time consuming. This, in combination with a limited number of qualified suppliers, may cause problems regarding long times of delivery. Hence, there is a need of improved pressure vessels and, particularly, pressure vessels that are capable of coping with the continuously increasing requirements and demands of the business and customers.

### SUMMARY OF THE INVENTION

It is an object of the present invention to provide improved devices and methods which alleviate at least some of the above mentioned problems.

This and other objects are achieved by providing a pressure vessel, a high-pressure press and a method for producing a pressure vessel having the features defined in the independent claims. Preferred embodiments are defined in the dependent claims.

According to a first aspect of the present invention, there is provided a pressure vessel comprising a pressure chamber arranged for accommodating a pressure medium. The pressure vessel further comprises at least one cylinder segment arranged for longitudinal connection to form a cylinder body, whereby a joint arranged for an interconnection is formed at adjacent longitudinal edges of the at least one cylinder segment. Moreover, the pressure vessel comprises pre-stressing means provided around an outer envelope surface of the cylinder body for radially pre-stressing the cylinder body and for at least partly decreasing a gap extending along at least a portion of each joint between adjacent longitudinal edges of the at least one cylinder segment.

According to a second aspect of the present invention, there is provided a high-pressure press for isostatic pressure treatment of articles, comprising a pressure vessel according to the first aspect of the present invention, including a force-absorbing press frame provided around the force absorbing pressure body.

According to a third aspect of the present invention, there is provided a method for producing a pressure vessel comprising a pressure chamber arranged for accommodating a pressure medium. The method comprises the step of providing a gap extending along at least a portion of each joint between adjacent longitudinal edges of the at least one cylinder segment. The method further comprises the step of pre-stressing an outer envelope surface of the cylinder body for radially pre-stressing the cylinder body, wherein the gap extending along the joint between the adjacent longitudinal edges of the at least one cylinder segment at least partly decreases when pre-stressing the cylinder body. It will be appreciated that the resulting cylinder body is closable at its open ends by closing lids, thereby enclosing a pressure chamber.

The pressure vessel of the present invention is based on the insight that a pressure vessel having an increased strength can be achieved by providing a gap that extends along at least a portion of each joint between adjacent longitudinal edges of the at least one cylinder segment of the pressure vessel, wherein pre-stressing means are provided for at least partly decrease the gap during pre-stress. When assembling the at least one cylinder segment into a cylinder body, the gap may be arranged for a contraction of the interconnection. By this, tensile stresses are reduced, leading to an increased strength of the weld, and consequently, of the cylinder body. Then, at pre-stress, the pre-stressing means at least partly decrease the gap.

More specifically, the interconnection at the joint at adjacent longitudinal edges, wherein the interconnection may be e.g. a weld, braze and/or solder, may contract upon cooling in the gap between the at least one cylinder segment, thereby avoiding residual stress in an circumferential direction of the cylinder body. Generally when welding, the local temperature of the weld may be substantially above that of the metal of the segments that are to be connected. This causes a local thermal expansion of the weld during welding and a subsequent contraction of the weld after welding. Hence, upon cooling, when the weld solidifies and shrinks due to thermal contraction, tensile stresses may be yielded in a circumferential direction between the segments. The pressure vessel of the present invention overcomes this problem, as the gap which is provided when assembling the cylinder segments by welding the cylinder segments along the joints allows the weld to contract with a significantly reduced stress in the circumferential direction of the cylinder body.

Furthermore, during operation of the pressure vessel, the pre-stressing means exerts forces on the cylinder segments in a circumferential direction of the cylinder body, i.e. forces directed in a circumferential direction such that the cylinder segments are pressed together. However, the joint between the cylinder segments may be affected by a separating force exerted by the pressurized medium. The pre-stressing means is arranged to counteract this separating force and is further sufficiently large enough to completely counteract and neutralize the separating force such that the resulting force is a compressive force in the circumferential direction of the cylinder body. In turn, this further contributes to an interconnection being free from tensile stress in a circumferential direction. This is advantageous, as it is preferred to have a compressive stresses in the weld (compared to the situation of a tensile stresses in the weld) for an increased strength of the weld, and consequently, of the cylinder body.

Furthermore, pre-stress from the pressure vessel in an axial direction of the cylinder body counteracts any tensile stress in the interconnection in the axial direction. Consequently, the interconnection (e.g. the weld) may be almost or completely free from tensile stresses in a circumferential and/or axial direction of the cylinder body when the pressure vessel is axially and radially pre-stressed when the pressure medium is pressurized.

An advantage with the present invention is that the operation of pressure vessels in isostatic pressing is improved in terms of safety. As the gap extending along at least a portion of each joint before pre-stress provides a reduced stress of the weld in a circumferential direction of the cylinder body, the strength of the weld is increased. As a result, the weld becomes more capable of sustaining high pressures and, in case of HIP, also high temperatures, compared to prior art techniques. This is of significant importance, as the pressure vessel of the present invention reduces the risk of failure of the pressure vessel. As an example, failure causes of pressure vessels may be due to e.g. material cracks, which may occur from crack initiation and propagation. The present invention improves the above-mentioned safety aspects and provides an ameliorated reliability in the operation of the pressure vessel. For example, the present invention may improve the safety of pressure vessels of extremely powerful HIP presses which are in development. In these presses, also known as “Giga-HIPs”, extreme pressures of several hundreds of MPa may be reached.

A further advantage with the present invention is that the interconnection between cylinders segments may be performed e.g. by the use of a welding additive material. As the additive material may improve the meltability during welding and provide a high creep rupture strength after solidification, the present invention provides an even more improved interconnection of the cylinder segments to form the cylinder body. Furthermore, after welding, the weld may be treated by annealing to provide advantages to the weld such as an improved ductility, internal stress relief, structure refinement by making it homogeneous, and/or improved cold working properties.

By assembling cylinder segments into a cylinder body by an interconnection such as welding, the present invention provides the further advantage of a manufacture of cylindrical pressure vessels of larger dimensions than manufactured today. A cylinder body comprising cylinder segments which are welded together is not limited by obstacles related to the manufacturing process of one single large cylinder.

Furthermore, the present invention is advantageous regarding transports of the pressure vessels to the assembly site, i.e. that the pressure vessel can be transported in segments from the forger or the like, to the manufacturing and assembly site. For example, the present invention may contribute to the transportation and assembly of “Giga-HIPs”, which may be taller than 12 m and weigh over 600 tons. The arrangement of cylinder segments for the construction of a cylinder body benefits from the improved welding arrangement of the present invention which reduces residual stress of the weld. As a consequence, cylinder bodies of e.g. HIP presses may be constructed from cylinder segments, which are more easily transported compared to one-piece cylinders. Hence, one-piece constructions of very big pressure cylinders may be avoided.

A further advantage with the pressure vessel of the present invention is that the manufacture and transport of the cylinder body becomes cheaper. This manufacture of a cylindrical body in segments, wherein the segments may be identical, is more economically beneficial than the production of a cylinder body, which may be extremely large, in one piece. Furthermore, as the segments of the cylinder body are less bulky compared to a one-piece cylinder body, the transport of the cylinder body segments may be provided easier and faster, which also may have the consequence of a cheaper transport.

The pressure vessel of the present invention comprises at least one cylinder segment arranged for longitudinal interconnection to form a cylinder body around the pressure chamber. In other words, the cylinder segments, which are assembled (mounted) into a cylinder body are elongated in the direction of the cylinder body axis. By the phrasing “at least one cylinder segment”, it is here meant that the cylinder body comprises one or more cylinder segments which form the cylinder body. In the case of one single segment, the single segment may be shaped into a single cylinder-shaped body, wherein the longitudinal edges of the segment will arrive in a position where they are adjacent each other. It is also possible to form several curved cylinder segments from e.g. metal plates and arrange them to form a cylinder body. Such curved cylinder segments may also be cast as segment blanks and then be forged into their final shape. The cylinder segments may in some cases be directly cast into their final curved shape and thereafter, if necessary, be given additional strength by forging.

By the term “joint”, it is here meant the junction or area of connection at adjacent longitudinal edges of the cylinder segments upon assembly of the cylinder body.

By the term “circumferential direction”, it is here meant the direction at the periphery of the cylinder body perpendicular to the axial direction, or, in other words, a direction parallel to the tangential direction

By the term “interconnection”, it is here meant a rigid connection between the at least one cylinder segments. As the interconnection may preferably be a weld, the term “interconnection” is in the text often referred to as a weld, for reasons of an improved understanding. By a weld provided along the joints at adjacent longitudinal edges of the cylinder segments, a pressure vessel comprising connected cylinders segments having fluid-tight seals at the joints may be obtained, preventing leakage of the pressure medium through the joints of the cylinder segments.

During an operation of emptying the pressure chamber from fluid, such as during the operation of a HIP, the sealing from the interconnection will prevent fluid outside the chamber to leak into the pressure chamber which increases the efficiency of a vacuum cycle. Consequently, the interconnection may provide a bi-directional sealing resulting in a leak-proof joint in both directions, i.e. from the chamber to the outside and vice versa.

After a welding between the cylinder segments, gap(s) may remain along at least a portion of the joint between the adjacent longitudinal edges of the cylinder segments, thereby slightly separating the cylinder segments along the at least a portion of each joint. The gap may at least partially be enclosed by the weld, or in other words, that the gap is realized as a void between the at least one cylinder segment in a axial direction, a radial direction, and/or a circumferential direction.

The pressure vessel comprises pre-stressing means which are provided around an outer envelope surface of the cylinder body, and which are arranged for radially pre-stressing the cylinder body. When the pressure vessel is pre-stressed in the radial direction, i.e. when the pre-stressing means around the pressure vessel apply a pre-stress on the cylinder segments of the cylinder body, the cylinder segments will be pressed together in a circumferential direction. When the cylinder segments are pressed together, the gap between adjacent cylinder segments will be decreased/reduced, and eventually, almost or completely disappear when more and more pre-stress is applied from the pre-stressing means. Hence, after pre-stressing the pressure vessel, there may be only portions of the gap(s), or virtually, no gap(s) at all, between the adjacent cylinder segments.

When the cylinder segments of the pressure vessel are pressed together by the pre-stressing means, it is desirable that the adjacent longitudinal edges of the cylinder segments interconnect evenly, such that the circumference of the cylinder body becomes smooth. For this purpose, the longitudinal edges of the cylinder segments may be thoroughly processed for providing an even interconnection. However, when pre-stressing the pressure vessel by the pre-stressing means, the pressure applied from the pre-stressing means in the radial direction strives to even any irregular formations of the cylinder body in a circumferential direction.

According to an embodiment of the present invention, at least one recess extending along at least a portion of each joint between adjacent longitudinal edges of the at least one cylinder segment may be arranged for a relief of stress from the pressure vessel. In other words, the recess may be arranged for a relief of pressure from the pressure medium in the pressure vessel in case of a crack formation in the cylinder body. The recess, which may be arranged in a longitudinal direction along the joint, may thereby absorb and transport pressure medium in a longitudinal direction from the interior of the cylinder body, thereby decreasing the pressure within the cylinder body and/or decreasing the risk of an even more severe crack formation in the cylinder body. For example, during operation of the pressure vessel, a crack may occur on the inside portion of a cylinder segment or segments of the cylinder body. Possibly, a crack may occur e.g. at the interconnection at the joint between cylinder segments or in a vicinity thereof. In the case of such a crack, a leak may occur between the cylinder body segments, from the cylinder body inside towards the recess.

The at least one recess in the embodiment of the invention may mitigate problems related to crack formations in the cylinder body, and may hinder any further crack propagation in the cylinder body. Hence, an advantage with the present embodiment is that the operation of pressure vessels in isostatic pressing is even further improved in terms of safety. As an interconnection, e.g. a weld, between cylinder segments of a cylinder body may constitute a critical point for the cylinder body, especially at extreme pressures of the pressure vessel, a recess arranged at the joint between adjacent longitudinal edges of the cylinder segments may hinder any further propagation of cracks, occurring at the weld. In this embodiment, the term “recess” may be interpreted as a hole, cavity or the like.

Hence, the pressure vessel may comprise a gap and/or a recess extending along at least a portion of each joint between adjacent longitudinal edges of the at least one cylinder segment, wherein the gap is arranged for a contraction of the interconnection and a relief of tensile stress of the interconnection, and wherein the recess is arranged for a relief of stress/pressure in case of crack formation. In other words, the gap may provide the advantage of an improved interconnection due to the reduction of tensile stresses in the weld before pre-stress, and the recess may provide a relief of stress in the case of crack formation at the interconnection. Whereas the gap between adjacent cylinder segments will be decreased/reduced, and eventually, almost or completely disappear when more and more pre-stress is applied from the pre-stressing means, a recess arranged at the joint may be still be almost or completely intact. It will be appreciated that a recess may be provided in the cylinder segments independently of the provision of a gap, i.e. the pressure vessel may comprise a gap, a recess, or both a gap and a recess.

According to an embodiment of the present invention, the interconnection may be e.g. a weld, braze, solder and/or cold weld. Hence, the connection between adjacent longitudinal edges may be provided by a process comprising fusion, when comprising a weld, a braze or a solder. Alternatively, the interconnection may possibly comprise no fusion, as in a cold weld. In this case, a cold weld implies a contact between the adjacent longitudinal edges of the at least one cylinder segment which are to be pressed together.

According to an embodiment of the present invention, the interconnection may be formed at at least a portion of the joint being exerted to a pressure from the pressure vessel. In other words, for at least a portion of the joint being exerted to a pressure during the operation of the high-pressure press, an interconnection may be formed at that portion such that the joint increases its strength. An advantage with the present embodiment is that an even more increased strength of the cylinder body to withstand high pressures is provided.

According to an embodiment of the present invention, the interconnection along the joint of the at least one cylinder segment may extend along at least a portion of the joint on the inside of the cylinder body. In other words, along the joints which may face the outside, the inside, the top and the bottom of the cylinder body, the interconnection may extend along at least a portion of the joint which faces the inside of the cylinder body. Hence, at least at the mentioned portion of the joint, the interconnection, such as e.g. a weld, provides the benefit of an interconnection that may withstand extreme pressures. Furthermore, at least at the mentioned portions, the interconnection seals the cylinder body such that a leakage of pressure medium, comprised in the cylinder body, is avoided.

According to an embodiment of the present invention, the depth of the interconnection along the joint of the at least one cylinder segment may be comprised between 0.25-10 mm, preferably between 0.5-3 mm. By the term “depth”, it is here meant a depth a direction substantially perpendicular to the elongated direction of the joint. For example, for a joint extending longitudinally between the cylinder segments, the depth of the interconnection, or weld, is in a radial direction of the cylinder body.

In the case of the interconnection being a weld, a too deep weld may cause excessive penetration weld bead formation and slow up weld travel speed which can lead to a deteriorated interconnection between the cylinder segments in the form of cold lapping. Moreover, gases generated during welding cannot readily escape, and the surface of the molten weld metal may be irregularly distorted. On the other hand, a too shallow weld depth may lead to a weld not being entirely submerged, which may have the consequence of a too porous and/or weak weld. By providing a depth of a weld along the joint of the cylinder segments between 0.25-10 mm, and preferably between 0.5-3 mm, the weld may more likely provide a tight and strong interconnection between the cylinder segments. For relatively small high-pressure presses, the depth of the weld may approximately be 0.5-1 mm, whereas for high-pressure presses, e.g. in the range of 100-200 MPa, the weld depth may be 2-7 mm, or even larger. It will be appreciated that the depth of the weld may be related to the thickness of the cylinder segments. For example, the weld depth may preferably be <5% of the thickness of the cylinder segment. For example, a weld depth of 4% of a cylinder segment thickness of e.g. 50 mm yields a weld depth of 2 mm.

According to an embodiment of the present invention, the pressure vessel may further comprise at least one pre-stressed surface provided on at least one side of the joint for taking up circumferential forces exerted thereon from the pre-stressing means, and wherein the at least one pre-stressed surface is arranged for transferring the circumferential forces via the at least one cylinder segment to the joint such that an additional circumferential compressive stress at the joint is attained.

An advantage with the present embodiment is that the transferred forces may further contribute to attaining compressive stress at the joint(s). More specifically, the at least one pre-stressed surface is arranged for transferring the forces exerted thereon in a circumferential direction towards the joint(s). As the area of the pre-stressed surface is smaller than the area of the edge of the cylinder segment, the pressure is augmented at the pre-stressed surface, thereby improving the sealing properties of the pressure vessel.

According to an embodiment of the present invention, the pressure vessel may be provided with at least one supporting means between the at least one cylinder segment, the at least one supporting means being arranged for providing the gap provided before pre-stressing the cylinder body. By the terms “supporting means”, it is here meant a relatively small element or elements to provide the gap between the cylinder segments such as e.g. a thread, a shoulder, a heel, a neck, a lip, a plug or the like. The supporting means may be provided in the case when the interconnection between the cylinder segments is performed with a welding method with a tight welding focus, such as electron beam welding and/or laser welding. However, this embodiment may also be appropriate for other welding techniques such as arc welding, plasma welding, TIG welding, MAG welding, etc. The use of a supporting means when applying a fine or tight welding method may be preferred as some welding methods may not be able to weld at a joint between two adjacent longitudinal edges of the cylinder segments having a relatively large gap. The supporting means of this embodiment of the present invention may provide a relatively small gap between the cylinder segments. For example, the supporting means may be provided at an end portion or portions of the gap for providing the gap between the cylinder segments.

According to an embodiment of the present invention, the gap provided before pre-stressing the cylinder body may extend along at least a portion of each joint in an axial direction, along at least a portion of each joint in a radial direction, and extends between the at least one cylinder segment in a circumferential direction. In other words, the gap may be realized as a void which at least partially extends between the at least one cylinder segment in an axial direction, a radial direction, and/or a circumferential direction, before pre-stressing means at least partly decreases the gap.

An advantage with this embodiment is that the gap, which may be provided along at least a portion of each joint, still provides a reduced stress of the weld in a circumferential direction of the cylinder body, whereas portions of the longitudinal edges not being separated by a gap may e.g. provide an additional stability to the interconnection of the cylinders segments.

As an example of the gap extending in a circumferential direction, the longitudinal edges of the cylinder segments may be provided in shapes of steps, or any other shape, such that the gap along each joint is not continuous. In other words, the longitudinal edges may, at at least a portion of the edges, not be separated by a gap.

According to an embodiment of the present invention, the width of the gap provided before pre-stressing the cylinder body may be comprised between 0.1-5 mm, preferably between 0.5-1.5 mm. By the term “width”, it is here meant a width in a circumferential direction of the cylinder body, i.e. a width between the facing adjacent edges of the cylinder segments. If the gap between the cylinder segments is too small, the possibility of the weld to contract in the joint between the cylinder segments after welding may be limited. On the other hand, if the gap is too wide between the cylinder segments, the risk of an un-tight and/or weak weld may occur. Hence, if the gap is comprised between 0.1-5 mm, preferably between 0.5-1.5 mm, the gap may improve the conditions for a weld that provides a tight and strong interconnection between the cylinder segments and wherein the gap may counteract residual stress in an circumferential direction of the cylinder body.

It will be appreciated that the width of the gap may be related to the thickness of the cylinder segments which are to be interconnected. As an example, the width of the gap may be approximately 10% of the cylinder segment thickness. For example, if the thickness of the cylinder segment is 10 mm, the width of the gap may be approximately 1 mm.

Furthermore, it will be appreciated that after interconnection of the at least one cylinder segments, the pre-stressing means are arranged to at least partly decrease/reduce the gap extending along at least a portion of each joint between adjacent longitudinal edges of the at least one cylinder segment.

According to an embodiment of the present invention, at least two, preferably in the range of four to eight, cylinder segments may be arranged to form a cylinder body around the pressure chamber. An advantage of arranging four to eight cylinder segments to form a cylinder body is that the number of cylinder segments is sufficient for the ability of providing the benefits related to such an arrangement, such as e.g. an easier transport and manufacture of the relatively smaller cylinder segments compared to an arrangement of fewer and larger cylinder segments. Furthermore, the number of preferred cylinder segments is sufficiently low for avoiding an arrangement wherein an excessive number of cylinder segments may lead to the excessive welding at each joint of the cylinder segments and/or an increased risk for the occurrence of an uneven cylinder shape of the cylinder body when interconnecting all cylinder segments.

According to an embodiment of the present invention, the joints of the at least one cylinder segment may extend along the perimeter of the cylinder body essentially helically and co-axially to the longitudinal axis thereof. In other words, the cylinder segments may be slabs which essentially take on shapes of parallelograms which further are arched in a circumferential direction. In this embodiment, instead of the joints extending parallel to the axis of the cylinder body, the joints between adjacent cylinder segments edges extend from one end of the cylinder body to the other along a helical path in the cylinder body. Hence, the gap which is provided between the adjacent helical edges of the cylinder segments may in this embodiment also be helical-shaped. An advantage with the present embodiment is that if a crack formation starts to occur, the crack may propagate in a direction out from the weld. For example, a crack which propagates in a substantially axial direction, may in this case not develop along a weld which direction evolves helically around the cylinder body. Hence, the embodiment of the present invention may contribute to a cylinder body with an even more increased strength.

According to an embodiment of the present invention, the pre-stressing means may be band- or wire shaped, having e.g. an oval, round, square, or rectangular cross-sectional shape, and being wound around the outer envelope surface of the cylinder body. Wire-winding involves tightly wound wires or bands onto and around the outer surface of the cylinder body of the pressure vessel. During winding, the wires or bands are stretched, thereby inducing a pre-stress in the wires and bands, which provides radial, inward forces, acting on the cylinder body and inducing a pre-stress thereto. Thus, tightly wound pre-stressed wires around the operable pressure vessel will place the pressure vessel in a compressed and pre-stressed state.

According to an embodiment of the present invention, the pressure vessel may comprise at least two sub-cylinders arranged for axial connection to form a cylinder body, wherein the axially connected sub-cylinders are interconnected. In other words, one or more sub-cylinders in the present embodiment may comprise cylinder segments arranged for longitudinal interconnection to form a cylinder body, whereas these sub-cylinders thereafter may be arranged axially. The axially connected sub-cylinders may be welded or brazed along each joint of the interconnected sub-cylinders, wherein the joints are provided in a plane perpendicular to the cylinder body axis.

A pressure vessel comprising axially interconnected sub-cylinders which are welded together along the joints may permit even larger vessels compared with one-piece vessels and/or vessels obtained by arrangement of longitudinal connections of cylinder segments, since each of the sub-cylinders may be manufactured separately. If the pressure vessel is assembled locally at the press operation site, a cylinder body formed by separate sub-cylinders enables an easy transportation thereof due to smaller pieces.

Anyone of the embodiments discussed above and illustrated in the appended figures may advantageously be combined with anyone of the embodiments described in the co-pending applications “Welded sealing of pressure cylinder vessel” and “Pressure vessel and high-pressure press” by the same applicant, which hereby are incorporated herein by reference.

Moreover, in embodiments of the pressure vessel of the present invention, the pressure vessel may be operable within the pressure range of about 20 MPa to about 1500 MPa, and more preferably, within the pressure range of about 80 to about 220 MPa.

It will be appreciated that the specific embodiments and any additional features described above with reference to the pressure vessel are likewise applicable and combinable with the high-pressure press comprising the pressure vessel, according to the second aspect of the present invention, and the method for producing the pressure vessel, according to the third aspect of the present invention.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed description, the attached dependent claims, and from the appended drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a schematic illustration of a cylinder body according to one embodiment of the present invention;

FIG. 2 is a schematic illustrations of a joint arranged for an interconnection of two cylinder segments of the cylinder body;

FIG. 3 is a schematic illustrations of FIG. 2 provided with a pre-stressing wire winding; and

FIGS. 4-7 are cross-sectional views of the cylinder body, according to embodiments of the present invention.

### DETAILED DESCRIPTION OF THE PREFERRED EMBODIMENTS

The invention is mainly described with reference to a few embodiments. However, as is readily appreciated by a person skilled in the art, other embodiments than the ones disclosed are equally possible within the scope of the invention, as defined by the appended claims.

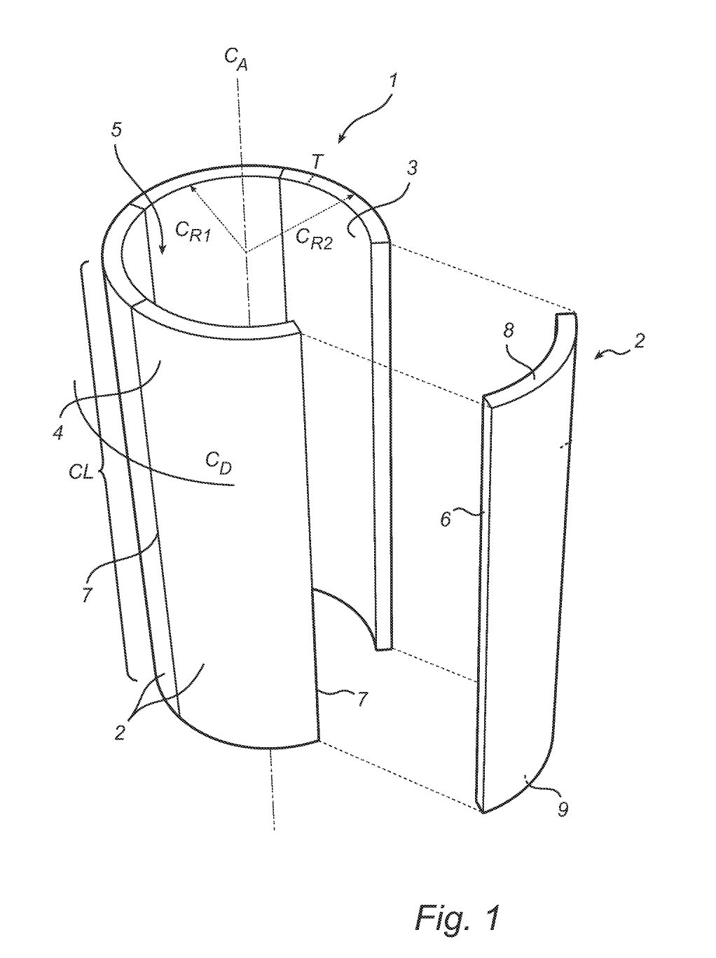

With reference to FIG. 1, there is schematically shown an illustration of a cylinder body 1 according to an embodiment of the present invention. The cylinder body 1 comprises five cylinder segments 2, wherein each cylinder segment 2 is shaped as an essentially rectangular slab. The lengths of the cylinder segments 2 extend in parallel with the cylinder axis C_{A}, wherein the lengths of the cylinder segments 2 define C_{L}, being the length of the cylinder body 1. The widths of the cylinder segments 2 are slightly arched in a circumferential direction C_{D} such that the cylinder segments 2 are arranged for connecting each other in the circumferential direction C_{D}, thereby forming the cylinder body 1.

Although the depicted cylinder body 1 in FIG. 1 comprises five cylinder segments 2 arranged to form the cylinder body 1, it is of course conceivable to construct a cylinder body 1 of, practically, any number of cylinder segments 2. Preferably, the cylinder segments 2 are formed in accordance with the description herein, which entails that the cylinder segments 2 may be assembled in accordance with the description in the co-pending applications “Welded sealing of pressure cylinder vessel” and/or “Pressure vessel and high-pressure press” to form the cylinder body 1. Further advantages and design and construction details of the cylinder segments are described thoroughly in the said co-pending applications by the same applicant, which hereby is incorporated herein by reference.

The cylinder body 1 has an inner cylinder radius C_{R1} from the cylinder axis C_{A}, through the centre of the cylinder 1, to an inner surface 3 of the cylinder body 1, and an outer radius C_{R2} from the cylinder axis C_{A} to an outer surface 4 of the cylinder segments 2. The thickness T of the cylinder segments 2 is hence T=C_{R2}−C_{R1}. When the cylinder body 1 is assembled, the inner surfaces 3 of the cylinder segments 2 define a pressure chamber 5. Further, the cylinder body 1 may be closed at the ends by lids (not shown) which are held in place by a framework (not shown).

At adjacent longitudinal edges 6 of the cylinder segments 2, joints 7 are formed between the cylinder segments 2, wherein each joint 7 extends essentially in parallel with the cylinder axis C_{A} and extends the entire cylinder body length C_{L}.

At the top and bottom of the segments 2, the segments 2 form a top edge 8 and a bottom edge 9, respectively, wherein these are flat. The top edge 8 and the bottom edge 9 each forms a common plane, i.e. the segments 2 are leveled.

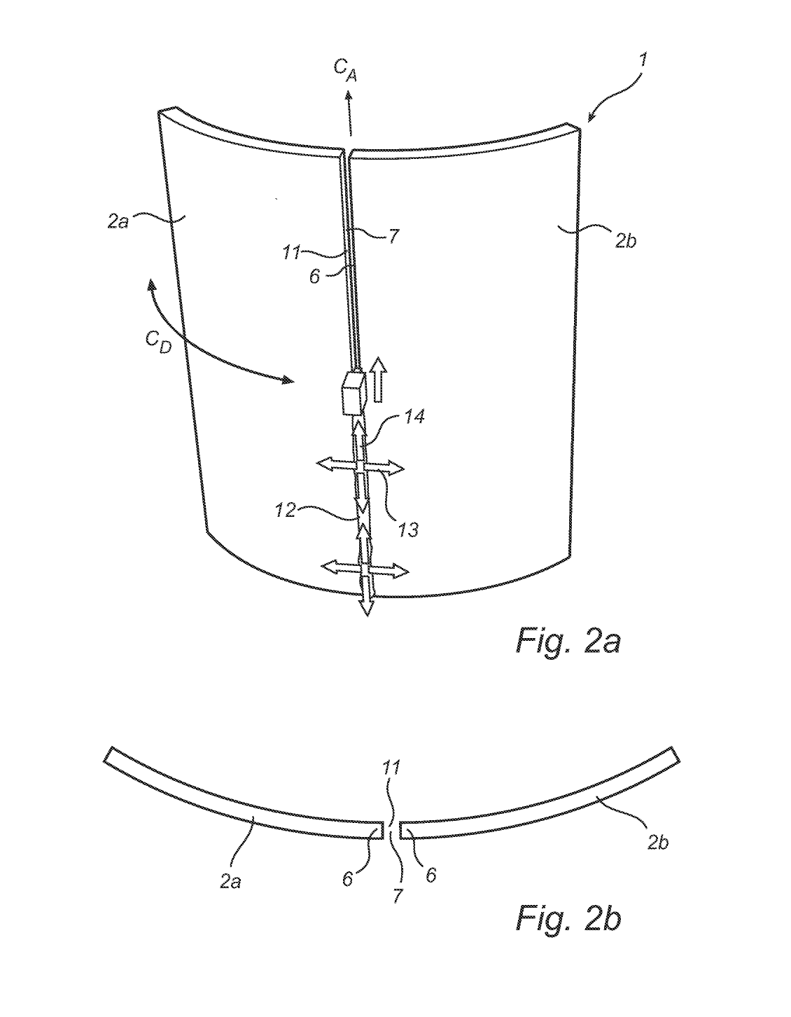

In FIG. 2a, there is schematically shown a part of the assembly of the cylinder body 1 between two cylinder segments 2a, 2b. A gap 11 extends along the joint 7, between the adjacent longitudinal edges 6 of the cylinder segments 2a, 2b. When interconnecting the cylinder segments 2a, 2b to form the cylinder body 1, e.g. by welding, the temperature of a weld 12 may be substantially above that of the metal of the cylinder segments 2a, 2b. Upon cooling of the weld 12, when the weld 12 solidifies and shrinks due to thermal contraction, stresses 13 may arise in a circumferential direction C_{D}, i.e. in a direction in a plane of the cylinder body 1 perpendicular to the cylinder axis C_{A} and perpendicular to the elongation of the joints 7. Furthermore, stresses 14 may also arise in an axial direction C_{A}. By the gap 11 extending along the joint 7 when welding or brazing, the cylinder segments 2 along the joints 7 allows the weld 12 to contract with a significantly reduced stress 13 and 14 in the circumferential direction C_{D} and the axial direction C_{A} of the cylinder body 1.

FIG. 2b shows an above view, i.e. along the axial direction C_{A}, of FIG. 2a, for a better understanding of the figure. It will be appreciated that FIG. 2b is for illustrative purposes only, and that any dimensions, e.g. the gap 11, may be different from those shown.

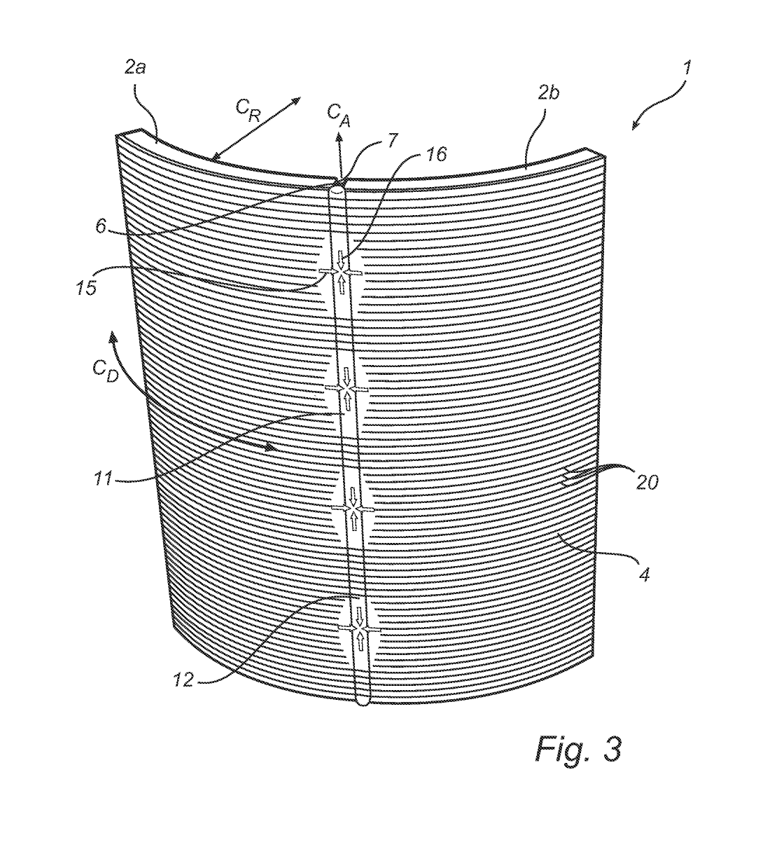

With reference to FIG. 3, there is schematically shown an illustration of a part of a cylinder body 1. The figure shows the connection between the two cylinder segments 2a, 2b, as previously shown in FIG. 2a, wherein the welding has been performed at the joint 7 of the longitudinal edges 6 between the cylinder segments 2a, 2b. The two cylinders segments 2a, 2b are connected by the weld 12 which runs along the joint 7 between the cylinder segments 2a, 2b. The weld 12 thereby provides a sealing arrangement for the joint 7, i.e. a sealing where the cylinder segments 2a, 2b are connected and in contact with each other.

The outer surface of the cylinder body 4 is provided with a pre-stressing means in the form of a package of wound steel bands 20. The bands 20 are tightly wound in a helical manner around the envelope surface in the circumferential direction C_{D} of the cylinder body 1 to provide a compressive stress in a radial direction C_{R} in the pressure chamber. When the cylinder body 1, which comprises a plurality of cylinder segments arranged longitudinally, is pre-stressed with the bands 20 arranged circumferentially around the cylinder body 1, the construction may resemble that of a beer barrel.

The pre-stress from the bands 20 presses the cylinder segments 2a, 2b against each other in the circumferential direction C_{D}, at the adjacent longitudinal edges 6, yielding a compressive stress 15 in the weld 12. As a response to this compressive stress 15, the weld 12 wants to expand in the circumferential direction C_{D}, and also in the axial direction C_{A}. The high-pressure press counteracts any expansion of the weld 12 in the axial direction C_{A}, thereby counteracting axial tensile stresses in the weld 12. Hence, instead of tensile stresses in an axial direction C_{A} and/or circumferential direction C_{D} in the weld 12, the pre-stressing means 20 provides compressive stresses 15 in the weld 12 in the circumferential direction C_{D}, and the stress applied from the high-pressure press in the axial direction C_{A} provides compressive stresses 16 in the weld 12 in the axial direction C_{A}.

Due to the pre-stress from the bands 20, the gap 11 between the adjacent cylinder segments 2a, 2b will be decreased/reduced, and eventually, almost or completely disappear, when more and more pre-stress is applied from the bands 20. In other words, the magnitude of the pre-stress from the bands 20 may result in a complete, or at least partial collapse, of the gap 11. More specifically, the reduction of the gap 11 may be explained from a half-circular cylinder segment which is pre-stressed with bands 20. The force onto the cylinder body 1 is to be counteracted by forces onto e.g. two pre-stressing edges/surfaces of the cylinder segment at each end point of the cylinder segment. The pressure applied onto the cylinder body 1, i.e. the force divided by the convex area of the cylinder body 1 projected radially, is greatly magnified in terms of the pressure onto the two edges/surfaces of the cylinder segment, as the areas of the edges are significantly smaller than the area from the dimensions of the cylinder body 1. Hence, as the pre-stress from the bands 20 may be in magnitudes of hundreds of GPa, the pressure becomes higher than the tensile yield limit of the cylinder segment edges, and the gap 11 between the adjacently arranged cylinder segments will decrease, and eventually, vanish, as the cylinder segments are pressed together.

At least one pre-stressing surface (not shown) may be provided on either side of the joint 7 for taking up circumferential forces exerted thereon when the pressure medium is pressurized. The pre-stressing surfaces are arranged for transferring the circumferential forces via the cylinder segments 2a, 2b to the joint 7 such that an additional circumferential compressive stress at the joint 7 is attained. Hence, the pre-stressing surfaces may further contribute to compressive stresses 15 in the weld 12 in the circumferential direction C_{D}.

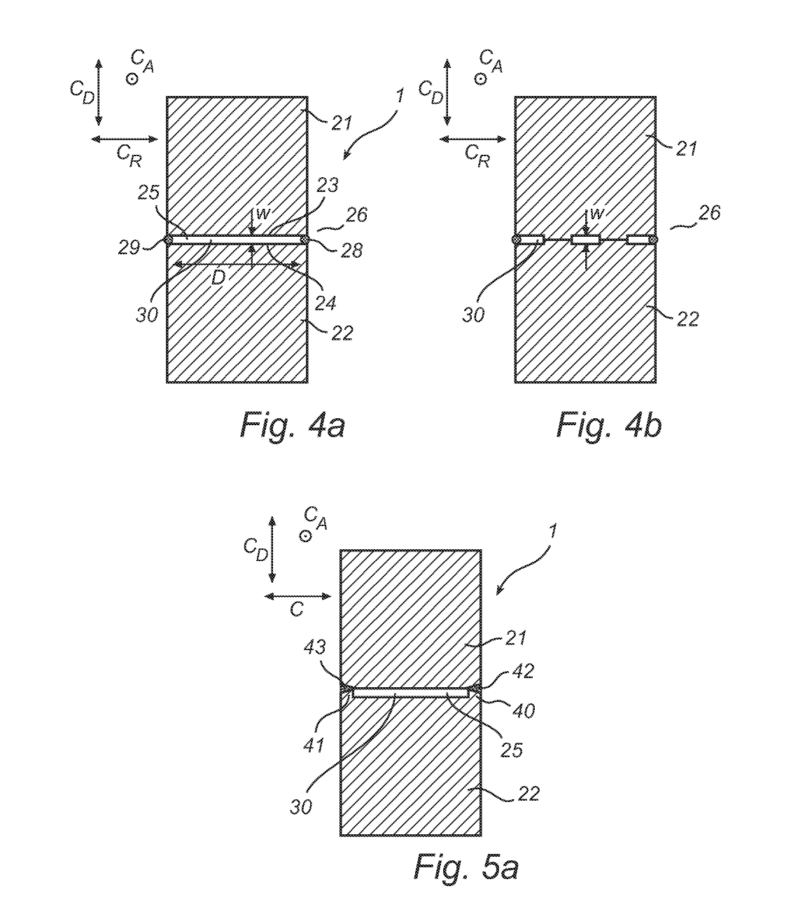

In FIG. 4a, a portion of the cylinder body 1 is shown along a direction of the cylinder axis C_{A}, wherein a first cylinder segment 21 and a second cylinder segment 22 are arranged for a longitudinal connection. At adjacent longitudinal edges 23, 24 of the cylinder segments 21, 22, respectively, a joint 25 is formed. The joint 25 is arranged for an interconnection 26, wherein the interconnection 26 may be e.g. a weld. The interconnection 26 may be provided e.g. along portions of the joint 25 at adjacent longitudinal edges 23, 24 on the inside of the cylinder body 1 and on the outside of the cylinder body 1. In FIG. 4a, the interconnection 26 is shown as a weld 28 on the inside of the cylinder body 1 and a weld 29 on the outside of the cylinder body 1. The welds 28, 29 extend along an axial (longitudinal) direction, i.e. in a direction of the cylinder axis C_{A}. Furthermore, the welds 28, 29 protrude in a radial direction C_{R}, yielding a depth of the welds 28, 29. For example, the depth of the welds 28, 29 may be approximately less than 5% of the thickness of the cylinder segments 21, 22.

Alternatively, there may be only one interconnection 26 at the joint 25 at the adjacent longitudinal edges 23, 24 of the cylinder segments 21, 22. For example, only the weld 28 provided along at least a portion of the joint 25 on the inside of the cylinder body 1 may be provided.

A gap 30 extends along at least a portion of the joints 25 between adjacent longitudinal edges of the first cylinder segment 21 and the second cylinder segment 22 in the directions C_{A}, C_{D} and C_{R} of the cylinder axis before pre-stressing the cylinder body. For example, the gap 30 may extend substantially the entire length of the longitudinal edges 23, 24 in the direction C_{A}, further extend in the direction C_{D} as the width W of the gap, and in the direction C_{R} as the depth D of the gap. In the circumferential direction C_{D}, between the first and the second cylinder segments 21, 22, the width W of the rectangular-shaped gap 30 shown in FIG. 4a may be 0.1-5 mm, preferably between 0.5-1.5 mm.

In the radial direction C_{R}, the gap 30 may extend along at least a portion of the joint 25 between adjacent longitudinal edges of the first cylinder segment 21 and the second cylinder segment 22 with a depth D. For example, the depth D of the gap 30 as shown in FIG. 4a may extend approximately 90% of the thickness of the cylinder segments 21, 22.

The top portion and the bottom portion (not shown) are sealed with an interconnection, enclosing the gap 30.

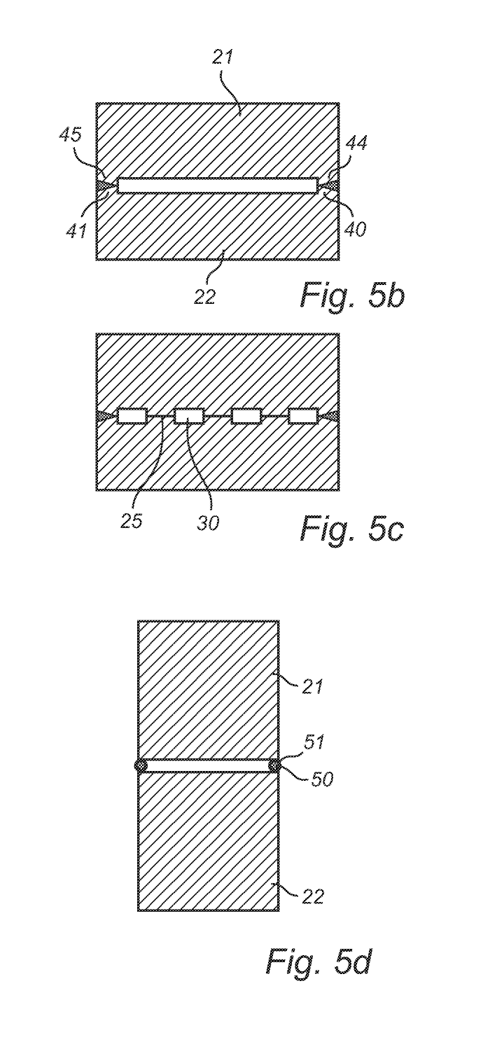

FIG. 4b shows an example wherein the gap 30 is realized with a step-like shape, i.e. from the inside to the outside of the cylinder body 1, the gap 30 varies its width W in the circumferential direction C_{D} from a width, such as a width W within the interval of e.g. 0.1-5 mm, to substantially no width, i.e. that the cylinder segments 21, 22 connect without any intermediate gap 30. Although a gap 30 having a step-like shape is shown in FIG. 4b, any other shape may be comprised in the meaning of a gap 30 extending along at least a portion of each joint 25. For example, the gap 30 may be saw-tooth shaped, or comprising any other regular or irregular pattern between the cylinder segments 21, 22. In FIG. 5a, a portion of the cylinder body 1 is shown along a direction of the cylinder axis C_{A}, similar to FIG. 4a and FIG. 4b. A supporting means 40 is provided at the end portion of the joint 25, towards the inside of the cylinder body 1. Analogously, a supporting means 41 is provided at the end portion of the joint 25, towards the outside of the cylinder body 1. The supporting means 40, 41 may be relatively small elements to provide the gap 30 between the cylinder segments 21, 22 such as e.g. a thread, a shoulder, a heel, a neck, a lip, a plug or the like. The supporting means 40, 41 may be provided in the case when the interconnection 26 between the cylinder segments 21, 22 is performed with a welding method with a relatively tight welding focus. The joint 25 is interconnected by a weld 42 at the joint 25 along the inside of the cylinder body 1, and by a weld 43 at the joint 25 along the outside of the cylinder body 1. Alternatively, the welds 42, 43 may penetrate with smaller depths than those depicted in FIG. 5a.

In FIG. 5a, the supporting means 40, 41 protrude from the cylinder segment 22. In this way, the profile of the edge of the cylinder segment 22 comprises step-like shapes at the end portions of the joint 30, whereas the cylinder segment 21 is shown with a substantially flat edge. Alternatively, as shown in FIG. 5b, supporting means 44, 45 may protrude from the cylinder segment 21 at the end portion of the joint, at the outside and the inside of the cylinder body 1. Here, the gap is provided symmetrically between the cylinder segments 21, 22. Furthermore, other profiles of the joint may be feasible. For example, a plurality of supporting means are provided along the joint 25. This yields a step-like profile of the joint 25, which is shown in FIG. 5c.

Furthermore, the supporting means 40, 41 in FIG. 5a may serve as examples of pre-stressed surfaces 40, 41 provided on one side of the joint 25 for taking up circumferential forces exerted thereon from the pre-stressing means (not shown), such that an additional circumferential compressive stress at the joint 25 is attained.

In FIG. 5d, a supporting means 50 is provided between the cylinder segments 21, 22, wherein this supporting means may be a wire or a band. A spot weld 51 may be provided for connecting the supporting means 50 to the cylinder segments 21, 22.

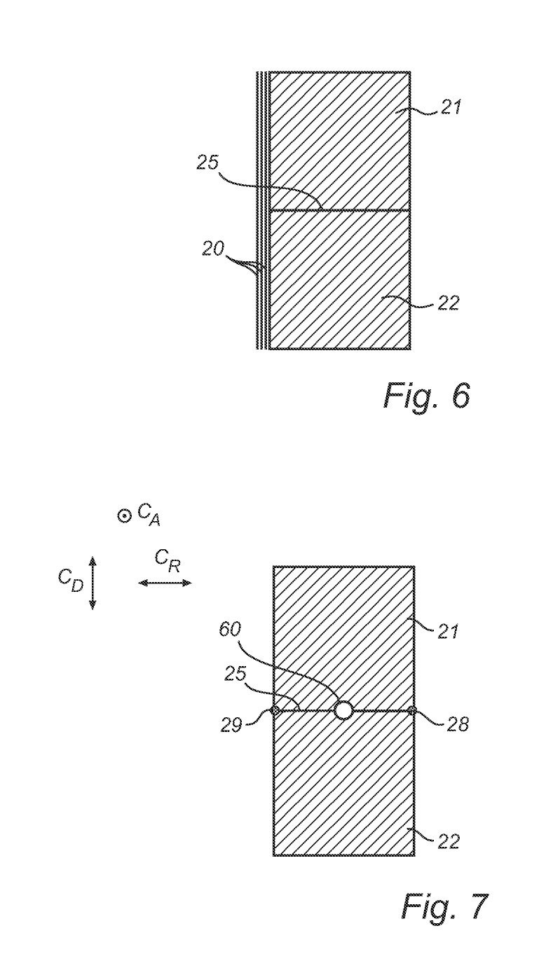

It will be appreciated that the gaps between adjacent longitudinal edges in FIGS. 2-5 are shown before the pre-stress from the bands 20 is applied. Hence, at pre-stressing, the gap(s) between the adjacent cylinder segments will decrease, and eventually, almost or completely disappear, when more and more pre-stress is applied from the bands 20. In other words, the magnitude of the pre-stress from the bands 20 results in a complete, or at least partial collapse, of the gap. This is shown in FIG. 6, wherein the pre-stress from the bands 20 have decreased the gap at the joint 25, such that there is, virtually, no gap between the adjacent cylinder segments 21, 22.

In FIG. 7, a recess 60 extends along the joint 25 between adjacent longitudinal edges of the cylinder segments 21, 22. The recess 60 is arranged for a relief of stress from the pressure vessel, in case of a crack. The recess 60 (or cavity, hole) is elongated longitudinally, i.e. in the axial direction C_{A}. In FIG. 6, the recess 60 is circular-shaped, which means that the recess 60 elongates in the axial direction C_{A} in the form of a hole or cavity cylinder. However, any other shape of the recess 60 may be feasible. Furthermore, the recess 60 is in the figure arranged approximately in the middle of the thickness of the cylinder segments 21, 22. However, the recess 60 may be provided essentially anywhere along the thickness of the cylinder segments 21, 22. For example, the recess 60 may be provided close to the interconnection (e.g. weld) 28 on the inside of the cylinder body, or close to the weld 29 on the outside of the cylinder body.

During operation of the pressure vessel, and especially during high-pressure operation, there may be a risk of crack formation of the cylinder body. A crack may occur e.g. at the interconnection 28 on the inside portion of the cylinder segments 21, 22, e.g. at the weld 28 at the joint between the cylinder segments 21, 22 or in a vicinity thereof. As a consequence, there may be a possible leak of pressure medium between the cylinder segments 21, 22, from the inside of the cylinder body. By providing a recess 60 between adjacent longitudinal edges of the cylinder segments 21, 22, the recess 60 may transport any pressure medium which may flow from the inside of the cylinder body to the recess 60. Then, the recess 60 may transport the pressure medium away from the inside of the cylinder body, in the axial direction C_{A}. By this, the pressure within the cylinder body may be decreased. Furthermore, the risk of an even more severe crack formation in the cylinder body may be decreased by the recess 60.

The length of the recess 60 may be the entire length of the cylinder segments 21, 22. Hence, in the case a crack occurs at e.g. the weld 28, pressure medium may penetrate between the cylinder segments 21, 22, into the recess 60, and further from the recess 60 out from the pressure vessel. The diameter of the recess 60 may be a compromise between the ability of a reliable stress relief of the pressure vessel in case of a crack, and the formation of cylinder segments 21, 22 that provide a sufficient thickness of goods between the inside and the outside of the cylinder body. For example, the diameter of the recess 60 may e.g. be approximately 10% of the thickness of the cylinder body.

Alternatively, the crack may develop from any other direction than at the joint 25 from the inside of the cylinder body. For example, the crack may instead propagate from the weld 29 at the outside of the cylinder body, and reach the recess 60. A crack formation at any other location than the interconnections 28, 29 at the joint 25 between the cylinder segments 21, 22 may also be feasible.

Although an exemplary embodiment of the present invention has been shown and described, it will be apparent to those having ordinary skill in the art that a number of changes, modifications, or alterations to the invention as described herein may be made. Thus, it is understood that the above description of the invention and the accompanying drawing is to be regarded as a non-limiting example thereof and that the scope of the protection is defined by the appended claims.

1. A pressure vessel comprising a pressure chamber (5) arranged for accommodating a pressure medium, comprising
at least one cylinder segment (2) arranged for longitudinal connection to form a cylinder body (1), whereby a joint (7) arranged for an interconnection (12) is formed at adjacent longitudinal edges (6) of the at least one cylinder segment, and
pre-stressing means (20) provided around an outer envelope surface (4) of the cylinder body for radially pre-stressing the cylinder body and for at least partly decreasing a gap (11) extending along at least a portion of each joint between adjacent longitudinal edges of the at least one cylinder segment.

2. The pressure vessel as claimed in claim 1, wherein the interconnection is e.g. a weld, a braze, a solder and/or cold weld.

3. The pressure vessel as claimed in claim 1, wherein the interconnection is formed at at least a portion of the joint being exerted to a pressure from the pressure vessel.

4. The pressure vessel as claimed in claim 1, wherein the interconnection along the joint of the at least one cylinder segment extends along at least a portion of the joint on the inside of the cylinder body.

5. The pressure vessel as claimed in claim 1, wherein the depth of the interconnection along the joint of the at least one cylinder segment is comprised between 0.25-10 mm, preferably between 0.530 2 mm.

6. The pressure vessel as claimed in claim 1, further comprising at least one pre-stressed surface provided on at least one side of the joint for taking up circumferential forces exerted thereon from the pre-stressing means, and wherein the at least one pre-stressed surface is arranged for transferring the circumferential forces via the at least one cylinder segment to the joint such that an additional circumferential compressive stress at the joint is attained.

7. The pressure vessel as claimed in claim 1, wherein at least one supporting means (40, 41,44,45) is provided between the at least one cylinder segment, the at least one supporting means being arranged for providing the gap provided before pre-stressing the cylinder body.

8. The pressure vessel as claimed in claim 1, wherein the gap provided before pre-stressing the cylinder body extends along at least a portion of each joint in an axial direction (C_{A}), wherein the gap extends along at least a portion of each joint in a radial direction (C_{R}), and wherein the gap extends between the at least one cylinder segment in a circumferential direction (C_{D}).

9. The pressure vessel as claimed in claim 1, wherein the width (W) of the gap provided before pre-stressing the cylinder body is comprised between 0.1-5 mm, preferably between 0.5-1.5 mm.

10. The pressure vessel as claimed in claim 1, wherein the joints of the at least one cylinder segment extend along the perimeter of the cylinder body essentially helically and co-axially to a longitudinal axis thereof.

11. The pressure vessel as claimed in claim 1, wherein the pre-stressing means is band- or wire shaped, having e.g. an oval, round, square, or rectangular cross-sectional shape, and is wound around the outer envelope surface of the cylinder body.

12. The pressure vessel as claimed in claim 1, further comprising at least two sub-cylinders arranged for axial connection to form a cylinder body, wherein the axially connected sub-cylinders are interconnected.

13. The pressure vessel as claimed in claim 1, wherein the pressure vessel is arranged to be operable in a pressure range comprised between 20 MPa-1500 MPa, preferably between 80 MPa-220 MPa.

14. A high-pressure press for isostatic pressure treatment of articles, comprising a pressure vessel as defined in claim 1, including a force-absorbing press frame provided around the force absorbing pressure body.

15. A method for producing a pressure vessel comprising a pressure chamber (5) arranged for accommodating a pressure medium, providing at least one cylinder segment (2) arranged for longitudinal connection to form a cylinder body (1), whereby a joint (7) arranged for an interconnection (12) is formed at adjacent longitudinal edges (6) of the at least one cylinder segment, the method comprising the steps of:
providing a gap (11) extending along at least a portion of each joint between adjacent longitudinal edges of the at least one cylinder segment, and
pre-stressing an outer envelope surface of the cylinder body for radially pre-stressing the cylinder body, wherein the gap extending along the joint between the adjacent longitudinal edges of the at least one cylinder segment at least partly decreases when pre-stressing the cylinder body.
